(19) United States
(12) Patent Application Publication
(10) Pub. No.: US 2008/0081204 A1
(43) Pub. Date: Apr. 3, 2008

(54) Elastic coated fabric and method for manufacturing the same

(76) Inventor: Chien-Kang Ho, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/540,973

(22) Filed: Oct. 2, 2006

(51) Int. Cl. B32B 25/04

(52) U.S. Cl. 428/492

(57) ABSTRACT

An elastic coated fabric and method for manufacturing the same are disclosed. The inventive method includes the steps of pouring into a opening-top mold an amount of liquid substance which would be elastic after coagulation, depositing a fabric substrate on the liquid substance, and coagulating the liquid substance to form an elastic coating on the fabric substrate's surface. The elastic coated fabric includes an elastic fabric substrate, and an elastic coating having a raised pattern consisting of at least one narrow strip attached to the elastic fabric substrate. The narrow strip is dimensioned and arranged so that it may be stretched in the same way as the elastic fabric substrate, thus enabling the elastic coating to be attached to the elastic fabric substrate closely and permanently.

### FIELD OF THE INVENTION

The present invention relates to a coated fabric and, more particularly, to an elastic coated fabric and method for manufacturing the same.

### BACKGROUND OF THE INVENTION

It is known that a protective band designed to be worn around the wrist, elbow or knee is made of an elastic coated fabric in order to closely fit the part of human body even when the part is in motion.

Most of the conventional protective bands have the same color as their constituent elastic fabrics have, thus being dull both in color and in appearance. Some of the protective bands are printed with a particular pattern, which, however, is planar but not raised.

As a result, some protective bands are designed to have a patterned piece of rubber or silica gel adhered to the elastic coated fabric so as to produce a three-dimensional view. Although the piece provides a raised pattern for the protective band, a problem still arises that the patterned piece will easily separate from and fall off the elastic coated fabric after the fabric is stretched repeatedly due to the motion of the person who wears the band. Besides, for the limitation of the manufacturing method, the piece can only have limited variations of pattern. For example, a pattern with edges and corners is unable to be presented. Moreover, the piece made of rubber silk can only have three kinds of color, i.e., black, gray, and white, so that it fails to be presented in a multiple-colored form.

Therefore, there is a need for an elastic coated fabric to overcome the shortcomings of the prior art.

### SUMMARY OF THE INVENTION

It is an objective of the present invention to provide a method for manufacturing an elastic coated fabric in which a fabric substrate is covered with an elastic coating having a colored, raised pattern.

Another objective of the present invention is to provide an elastic coated fabric in which the elastic coating may be attached to an elastic fabric substrate closely and permanently in spite of the repeated stretch of the fabric substrate due to the motion of the human body.

It is also an objective of the present invention to provide an elastic coated fabric in which an elastic coating has a raised pattern consisting of narrow strips in different sizes and colors so as to provide an attractive appearance for the elastic coated fabric.

To achieve the objectives mentioned above, the present invention provides an inventive method including the steps of: a) pouring into a opening-top mold an amount of liquid substance which would be elastic after coagulation; b) depositing a fabric substrate on the liquid substance; and c) coagulating the liquid substance to form an elastic coating on the fabric substrate.

As an aspect of the present invention, the opening-top mold may preferably have its inner bottom bearing a recessed pattern beforehand, so as to form an elastic coating with a raised pattern on the fabric substrate.

As another aspect of the present invention, the inventive method may preferably further include a step of applying pigment to the recessed pattern of the opening-top mold before the liquid substance is poured into the recessed pattern, so as to form an elastic coating with a colored, raised pattern on the fabric substrate.

The objectives of the present invention are also achieved by providing an elastic coated fabric including an elastic fabric substrate and an elastic coating having a raised pattern consisting of at least one narrow strip attached to the elastic fabric substrate. The narrow strip is dimensioned and arranged so that it may be stretched in the same way as the elastic fabric substrate, thus enabling the elastic coating to be attached to the elastic fabric substrate closely and permanently.

Other objectives, advantages and novel features of the present invention will become more apparent from the following detailed description when taken in conjunction with the accompanying drawings.

### BRIEF DESCRIPTION OF THE DRAWINGS

FIG. 1 is a flow chart of an inventive method for manufacturing an elastic coated fabric according to the present invention;

FIG. 2 is a schematic view showing a fabric substrate to be coated with an elastic coating according to the inventive method of the present invention;

FIG. 3 is a schematic view showing the fabric substrate coated with an elastic coating according to the inventive method of the present invention; and

FIG. 4 is a perspective view of an elastic coated fabric manufactured according to the inventive method of the present invention and shaped into an endless band.

### DETAILED DESCRIPTION OF THE PREFERRED EMBODIMENT

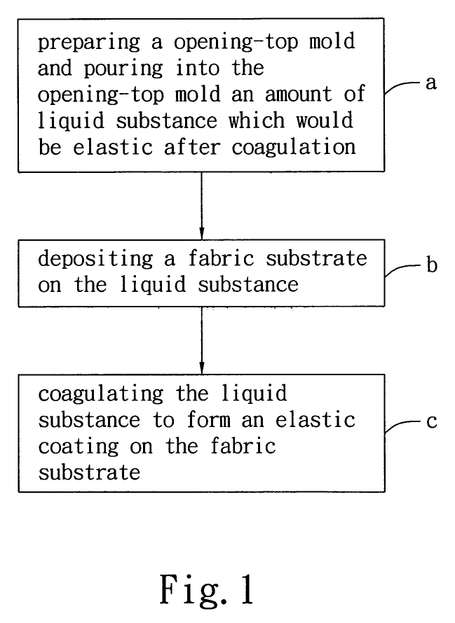

Referring to FIGS. 1 to 3, there is shown a preferred embodiment of an inventive method for manufacturing an elastic coated fabric. The method includes the steps of:

a) preparing a opening-top mold 1 and pouring into the opening-top mold 1 an amount of liquid substance 2 which would be elastic after coagulation;

b) depositing a fabric substrate 3 on the liquid substance 2; and

c) coagulating the liquid substance 2 to form an elastic coating 4 on the fabric substrate 3.

In the step a), the liquid substance may be polyurethane (PU) in a single-fluid or double-fluid state.

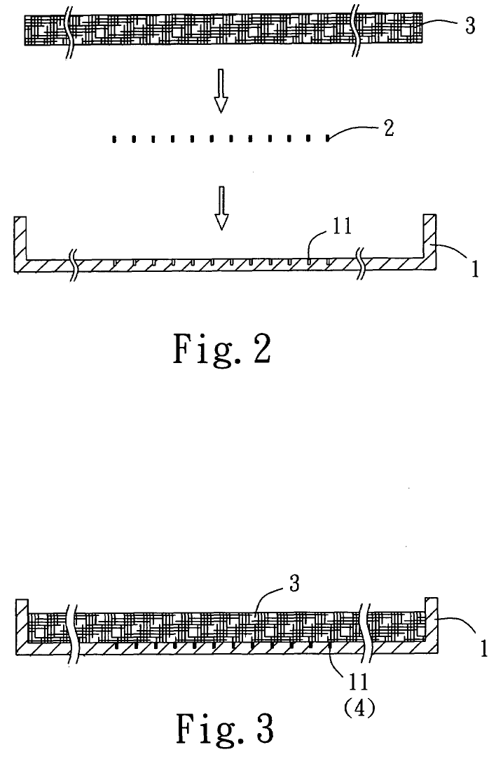

Referring still to FIGS. 2 and 3, the opening-top mold 1 preferably has its inner bottom bearing a recessed pattern 11 consisting of narrow grooves, so that the liquid substance 2 may form the elastic coating 4 having a raised pattern on the fabric substrate 3.

More preferably, pigment may be applied to the recessed pattern 11 of the mold 1 before the liquid substance 2 is poured, so that the liquid substance 2 in the recessed pattern 11 is mixed with the pigment and forms an elastic coating 4 having a colored, raised pattern on the fabric substrate 3. Alternatively, the liquid substance 2 may be mixed with the pigment before being injected or poured into the mold 1.

In step b), the fabric substrate may be an elastic cloth. In certain application, it may also be a usual or common fabric.

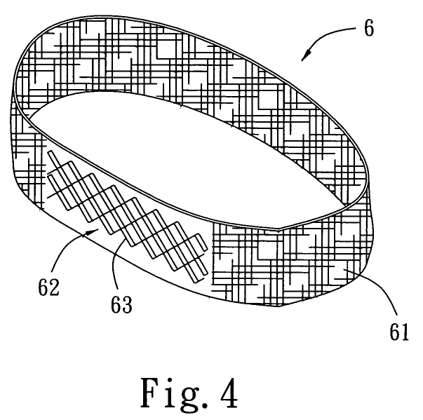

Referring to FIG. 4, an elastic coated fabric 6 manufactured according to the above-mentioned method includes a elastic fabric substrate 61 partially covered with an elastic coating 62.

In this illustrated embodiment, the elastic fabric substrate 61 is shaped into an endless band, which is to be used as a protective band worn around the wrist, elbow or knee of human body, especially for sport. The elastic fabric substrate 61 may also be shaped into a long strip or any other suitable shape for other purposes.

The elastic coating 62 is made of elastic substance, such as elastic plastic, rubber, or preferably polyurethane (PU) resin, and has a raised pattern 63 consisting of a plurality of crossed narrow strips, as clearly shown in FIG. 4. These narrow strips may be connected with each other or, alternatively, may be separate from each other.

As the elastic fabric substrate 61 is being stretched due to the motion of the human body, the narrow strips in such shape and arrangement enable themselves to be stretched in the same way as the fabric substrate 61, thereby ensuring the elastic coating 62 to be attached to the elastic fabric substrate 61 closely and permanently.

From the foregoing, it is apparent that the present invention is advantageous in that:

1. the elastic coating of the present invention can be closely attached to the elastic fabric substrate without the risk of separating therefrom; and

2. the elastic coating may have a raised pattern consisting of narrow strips in different sizes and colors, thereby providing the fabric substrate with an attractive appearance.

Although embodiments together with structures and functions of the present invention have been described in detail, many modifications and variations may be made from the teachings disclosed hereinabove. Therefore, it should be understood by those skilled in the art that any modification and variation equivalent to the spirit of the present invention be regarded to fall into the scope defined by the appended claims.

What is claimed is:

1. A method for manufacturing an elastic coated fabric, comprising the steps of:
d) pouring into a opening-top mold an amount of liquid substance which would be elastic after coagulation;
e) depositing a fabric substrate on said liquid substance; and
f) coagulating said liquid substance to form an elastic coating on the surface of said fabric substrate.

2. The method as claimed in claim 1, wherein said fabric substrate is an elastic cloth.

3. The method as claimed in claim 1, wherein said opening-top mold has its inner bottom side been disposed a recessed pattern before pouring the liquid substance, so as to form an elastic coating having a raised pattern on the surface of said fabric substrate.

4. The method as claimed in claim 3 further including a step of applying pigment to said recessed pattern of said opening-top mold before said liquid substance is poured into said recessed pattern, so as to form an elastic coating having a colored, raised pattern on said fabric substrate.

5. The method as claimed in claim 3, wherein said pattern consists of at least one narrow strip.

6. An elastic coated fabric, comprising:
an elastic fabric substrate; and
an elastic coating having a raised pattern consisting of at least one narrow strip attached to said elastic fabric substrate;
wherein said narrow strip is dimensioned and arranged so that it may be stretched in the same way as said elastic fabric substrate, thereby enabling said elastic coating to be attached to said elastic fabric substrate closely and permanently.

7. The elastic coated fabric as claimed in claim 6, wherein said elastic coating is made of elastic plastic or rubber.

8. The elastic coated fabric as claimed in claim 6, wherein said elastic fabric substrate is shaped into an endless band.
